(19) United States
(12) Patent Application Publication
(10) Pub. No.: US 2008/0063806 A1
(43) Pub. Date: Mar. 13, 2008

(54) PROCESSES FOR CURING A POLYMERIC COATING COMPOSITION USING MICROWAVE IRRADIATION

(75) Inventors: Robert Allen Janssen, Alpharetta, GA (US); Michael Joseph Garvey, Appleton, WI (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: Kimberly-Clark Worldwide, Inc., Neenah, WI (US)

(21) Appl. No.: 11/530,198

(22) Filed: Sep. 8, 2006

(51) Int. Cl. C08F 2/48; C08J 7/18

(52) U.S. Cl. 427/508; 427/553

(57) ABSTRACT

Processes for curing a polymeric coating composition to form a three dimensional structure that is capable of entrapping colorants such as dyes, pigments, and inks on the surface of substrates are disclosed. The polymeric coating composition includes a reactant compound and an oligomer and can be cured using microwave irradiation.

### BACKGROUND OF DISCLOSURE

The present disclosure generally relates to cross-linking a polymeric coating composition using microwave irradiation. More specifically, once cross-linked, the polymeric coating composition forms a cured three dimensional structure that is capable of entrapping colorants such as dyes, pigments, and inks on the surface of substrates. The substrates can include paper, non-wovens, films, glass, metals, plastics, and textiles.

In nearly all dyeing and printing processes, some fraction of the applied colorant will not bind to the substrate. These unbound dyes and reactants must typically be removed by a water rinsing process, generating large quantities of waste effluent. Furthermore, large quantities of colorant must be applied to the substrate to provide sufficient color intensity coverage after the dyeing process. As such, these conventional processes are inefficient and costly to the manufacturer.

There have been many attempts to trap colorant on the surface of substrates. For example, many previous attempts have relied upon free radical polymerization and cross-linking mechanisms to produce three dimensional structures to trap colorants.

These mechanisms, however, require the use of ultraviolet (UV) or electron beam (EB) exposure. Systems for undergoing UV and EB exposure are susceptible to polymerization inhibition by the oxygen in the air. Solutions for preventing polymerization inhibition are complex and costly. Additionally, both UV and EB radiation are surface limited in terms of penetration into the colorant material. As such, long dwell times under the radiation source or increased energy from the radiation source are required to cure the colorant compositions, thereby increasing the cost of the process and reducing production rate.

Based on the foregoing, there is a need in the art for a curing process that is capable of entrapping colorant onto a substrate without the use of UV or EB radiation. Additionally, it would be advantageous if the process could be conducted at lower temperatures and for a shorter period of time, thereby reducing manufacturing costs.

### SUMMARY OF THE DISCLOSURE

The present disclosure is directed to processes for curing a polymeric coating composition to form three dimensional structures that are capable of entrapping colorants such as dyes, pigments, and inks on the surface of substrates. Generally, a polymeric coating composition is formed by contacting a reactant compound and an oligomer. The polymeric coating composition is then deposited onto a substrate and the coated substrate is subjected to microwave irradiation to cross-link the composition to form a three-dimensional structure on the surface of the substrate. In one embodiment, the reactant compound and the oligomer are both in liquid form.

As such, the present disclosure is directed to a process of curing a polymeric coating composition. The process comprises: contacting a reactant compound with an oligomer to form a polymeric coating composition; depositing the polymeric coating composition onto a substrate; and subjecting the polymeric coated substrate to microwave irradiation such that the polymeric coating composition cross-links to form a three-dimensional structure on the substrate.

The present disclosure is further directed to a process of curing a polymeric coating composition. The process comprises: contacting a reactant compound having an epoxy moiety with an oligomer to form a polymeric coating composition; depositing the polymeric coating composition onto a substrate; and subjecting the polymeric coated substrate to microwave irradiation such that the polymeric coating composition cross-links to form a three-dimensional structure on the substrate.

The present disclosure is further directed to a process of curing a polymeric coating composition. The process comprises: contacting a reactant compound with an oligomer to form a polymeric coating composition, wherein the reactant compound is a tri-functional aziridine; depositing the polymeric coating composition onto a substrate; and subjecting the polymeric coated substrate to microwave irradiation such that the polymeric coating composition cross-links to form a three-dimensional structure on the substrate.

The present disclosure is further directed to a process of curing a polymeric coating composition. The process comprises: contacting a reactant compound having an anhydride moiety with a polyvinyl alcohol to form a polymeric coating composition; depositing the polymeric coating composition onto a substrate; and subjecting the polymeric coated substrate to microwave irradiation such that the polymeric coating composition cross-links to form a three-dimensional structure on the substrate.

Other features of the present disclosure will be in part apparent and in part pointed out hereinafter.

### BRIEF DESCRIPTION OF THE FIGURES

FIG. 1 is a schematic of one embodiment of a process for curing a polymeric coating composition using microwave irradiation.

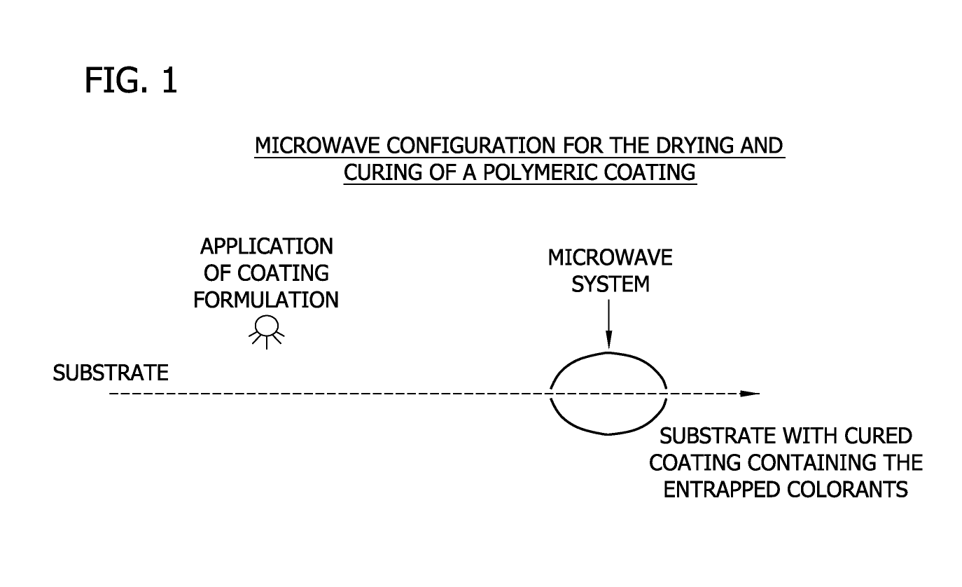

### DETAILED DESCRIPTION OF THE PREFERRED EMBODIMENT

The present disclosure is generally directed to curing a polymeric coating composition using microwave irradiation. More specifically, the present disclosure is directed to processes for microwave curing a polymeric coating composition to form three dimensional structures that are capable of entrapping colorants such as dyes, pigments, conductive inks, and inks on the surface of substrates. In one embodiment, the process for curing polymeric coating compositions comprises: contacting a reactant compound with an oligomer to form a polymeric coating composition; depositing the polymeric coating composition onto a substrate; and subjecting the polymeric coated substrate to microwave irradiation such that the polymeric coating composition cross-links to form a three-dimensional structure on the substrate.

To produce the polymeric coating composition for microwave curing, a reactant compound is contacted with an oligomer. The reactant compounds suitable for use in the present disclosure exhibit polar characteristics that provide the compounds with a strong affinity for microwaves. As such, when the reactant compounds absorb the microwave irradiation, the energy is converted to heat which can activate a cross-linking reaction of the oligomers.

Suitable reactant compounds for use in the processes of the present disclosure include, for example, compounds having at least one moiety selected from the group consisting of aliphatic epoxy, aromatic epoxy, aziridine, anhydride, and combinations thereof. In one particularly preferred embodiment, the reactant compound has at least one moiety selected from the group above, and the compound is in liquid form. By using a compound in liquid form, the reactant more readily contacts the oligomers, allowing for a more efficient cross-linking reaction to occur.

In one embodiment, the reactant compound has an aliphatic epoxy moiety. Examples of reactant compounds having aliphatic epoxy moieties include aliphatic diepoxide and aliphatic diacid glycidyl ester.

In another embodiment, the reactant compound has an aromatic epoxy moiety. Examples of reactant compounds having aromatic epoxy moieties include butadiene dioxide and 2,2-Bis(4-glycidyloxyphenyl)propane. One particularly preferred reactant compound having an aromatic epoxy moiety is Kymene 557LX® (commercially available from Hercules Incorporated, Wilmington, Del.).

In yet another embodiment, the reactant compound is a tri-functional aziridine. One particularly preferred tri-functional aziridine is XAMA-7® (commercially available from Sybron Chemical Incorporated, Pittsburg, Pa.).

In addition to the reactant compounds described above, the reactant compound can also be a compound having an anhydride moiety. Suitable compounds having anhydride moieties can include succinic anhydride and styrene-ethylene/butylene(succinic anhydride)-styrene. Two commercially available succinic anhydride-containing compounds, which are suitable for use as the reactant compound in the processes of the present disclosure, are FG-1901 and FG-1924X, both available from KRATON Polymers (Houston, Tex.).

As noted above, the reactant compound is contacted with an oligomer to form the polymeric coating composition. Suitable oligomers for use in the processes of the present disclosure include, for example, amines, alcohols, carboxylic acids, and combinations thereof. In one particularly preferred embodiment, the oligomer is in liquid form.

In one embodiment, the oligomer is an amine. Examples of suitable amines include ethylenediamine and hexamethylenediamine.

In another embodiment, the oligomer is an alcohol. Suitable alcohols for use as the oligomer in the processes of the present disclosure include, for example, polyvinyl alcohols, polyvinyl acetates, polyethylene glycols, polypropylene glycols, and cellulosics.

In yet another embodiment, carboxylic acids can suitably be used as the oligomer. Particularly preferred carboxylic acids include oxalic acid, malonic acid, succinic acid, glutaric acid, adipic acid, pimelic acid, maleic acid, polyacrylic acid polymers, and the like.

Generally, once contacted with the reactant compound and subjected to a thermal treatment, the oligomer cross-links to form a three-dimensional structure. By way of example, the following are typical reaction schemes between suitable reactant compounds and oligomers:

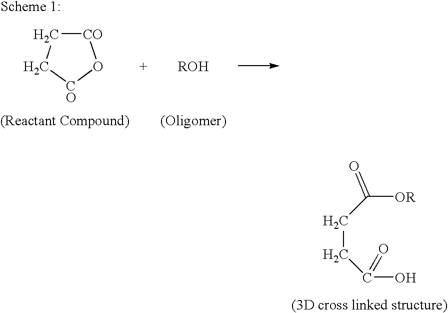

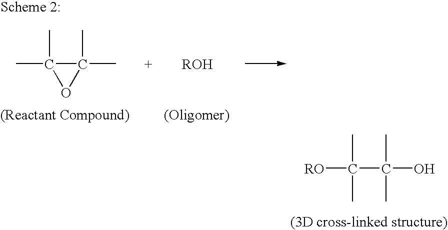

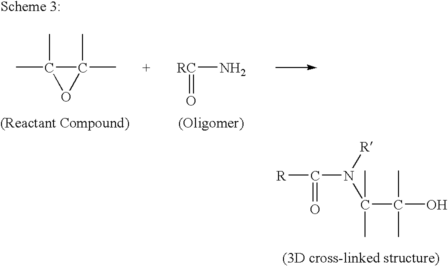

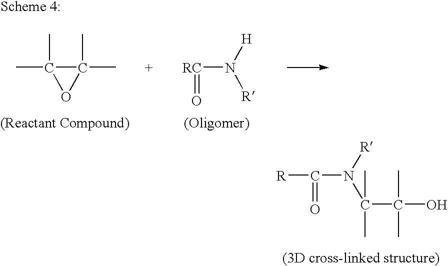

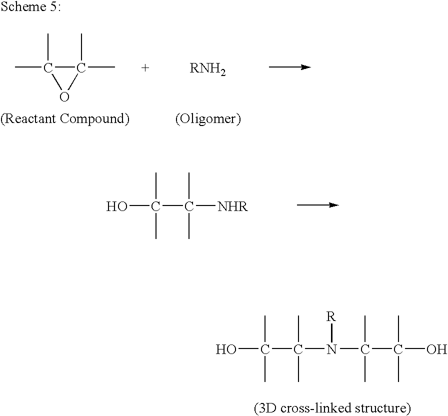

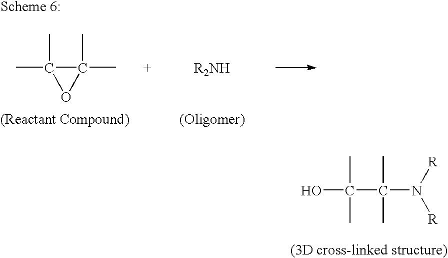

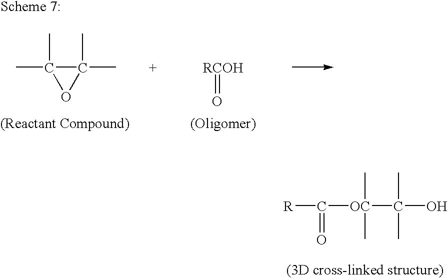

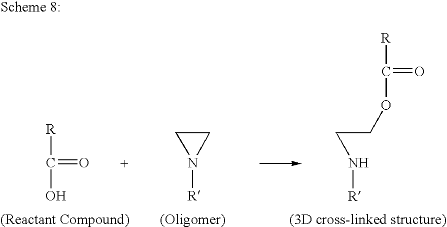

The amount of reactant compound and oligomer to be used in forming the polymeric coating composition depends on the type of reactant compound used. Furthermore, a diluent, such as water, can be used in forming the polymeric coating composition. Generally, the polymeric coating composition is formed using from about 0.01% (by weight total polymeric coating composition) to about 80% (by weight total polymeric coating composition) reactant compound and from about 20% (by weight total polymeric coating composition) to about 99.99% (by weight total polymeric coating composition) oligomer, with the balance being water. More suitably, the polymeric coating composition is formed using from about 0.1% (by weight total polymeric coating composition) to about 60% (by weight total polymeric coating composition) reactant compound and from about 40% (by weight total polymeric coating composition) to about 99% (by weight total polymeric coating composition) oligomer, with the balance being water. Even more suitably, the polymeric coating composition is formed using from about 0.1% (by weight total polymeric coating composition) to about 20% (by weight total polymeric coating composition) reactant compound and from about 40% (by weight total polymeric coating composition) to about 80% (by weight total polymeric coating composition) oligomer, with the balance being water, and even more suitably, using from about 0.1% (by weight total polymeric coating composition) to about 10% (by weight total polymeric coating composition) reactant compound and from about 40% (by weight total polymeric coating composition) to about 80% (by weight total polymeric coating composition) oligomer, with the balance being water.

More specifically, in one embodiment, when the reactant compound has an aliphatic and/or aromatic epoxy moiety, the polymeric coating composition is produced using from about 0.01% (by weight total polymeric coating composition) to about 60% (by weight total polymeric coating composition) reactant compound and from about 40% (by weight total polymeric coating composition) to about 99.99% (by weight total polymeric coating composition) oligomer, with the balance being water. More suitably, the polymeric coating composition of this embodiment is produced using from about 0.01% (by weight total polymeric coating composition) to about 20% (by weight total polymeric coating composition) reactant compound and from about 40% (by weight total polymeric coating composition) to about 99% (by weight total polymeric coating composition) oligomer, with the balance being water. Even more suitably, the polymeric coating composition is produced using from about 0.1% (by weight total polymeric coating composition) to about 10% (by weight total polymeric coating composition) reactant compound and from about 50% (by weight total polymeric coating composition) to about 70% (by weight total polymeric coating composition) oligomer, with the balance being water.

In another embodiment, when a tri-functional aziridine is the reactant compound, the polymeric coating composition is produced using from about 0.01% (by weight total polymeric coating composition) to about 60% (by weight total polymeric coating composition) reactant compound and from about 40% (by weight total polymeric coating composition) to about 99.99% (by weight total polymeric coating composition) oligomer, with the balance being water. More suitably, the polymeric coating composition of this embodiment is produced using from about 0.01% (by weight total polymeric coating composition) to about 20% (by weight total polymeric coating composition) reactant compound and from about 40% (by weight total polymeric coating composition) to about 99% (by weight total polymeric coating composition) oligomer, with the balance being water. Even more suitably, the polymeric coating composition is produced using from about 0.1% (by weight total polymeric coating composition) to about 10% (by weight total polymeric coating composition) reactant compound and from about 40% (by weight total polymeric coating composition) to about 80% (by weight total polymeric coating composition) oligomer, with the balance being water.

In yet another embodiment, when the reactant compound has an anhydride moiety, the polymeric coating composition is produced using from about 0.1% (by weight total polymeric coating composition) to about 80% (by weight total polymeric coating composition) reactant compound and from about 20% (by weight total polymeric coating composition) to about 99.9% (by weight total polymeric coating composition) oligomer, with the balance being water. More suitably, the polymeric coating composition is produced using from about 0.1% (by weight total polymeric coating composition) to about 60% (by weight total polymeric coating composition) reactant compound and from about 40% (by weight total polymeric coating composition) to about 80% (by weight total polymeric coating composition) oligomer, with the balance being water. Even more suitably, the polymeric coating composition is produced using from about 0.1% (by weight total polymeric coating composition) to about 10% (by weight total polymeric coating composition) reactant compound and from about 40% (by weight total polymeric coating composition) to about 80% (by weight total polymeric coating composition) oligomer, with the balance being water.

Recently, a wide variety of substrates have been produced to contain electrical circuitry for carrying signals and/or power to perform communication, display, heating, computation, etc. Such electrical circuitry may be wired by hand, but is typically embodied in a printed circuit board installed into a substrate. Accordingly, in some embodiments, an electrically conductive additive, ink, or pigment (collectively referred to herein as conductive additives) can advantageously be introduced into the polymeric coating composition to induce electrical conductivity. Suitable electrically conductive additives include dyes, pigments, conductive polymers, and combinations thereof. Additional advantages to using the above electrically conductive additives is that by mixing the colorants directly in with the polymeric coating composition, the colorants are more easily entrapped into the three dimensional structure once the polymeric coating composition is cured and the process of coating and curing a substrate with a colorant can be completed in a single efficient step.

Suitable dyes for use as conductive additives include acridines, anthraquinones, azos, cyanines, diazoniums, nitrosos, quinones, thiazoles, and the like.

Pigments that are suitable for use as conductive additives in the polymeric coating composition can include both inorganic and organic pigments such as, for example, phthalocyanine, melanin, carbon, cadmium, iron, chromium, cobalt, lead, copper, and the like.

Also suitable for use as a conductive additive is a conductive polymer. Suitable conductive polymers include polyacetylenes, polypyrroles, polythiophenes, polyanilines, and the like.

In one embodiment, the conductive polymers can be doped with a doping agent to produce conductive polymers having even greater conductivity properties as compared to the conductive polymers alone. Doping agents for use in the processes of the present disclosure include iodine, bromine, beryllium, magnesium, calcium, strontium, barium, radium, and the like. The doping agent can be used in an amount of from about 0.01% (by weight conductive polymer) to about 10% (by weight conductive polymer). More suitably, the conductive polymer can be doped with from about 01% (by weight conductive polymer) to about 5% (by weight conductive polymer) doping agent.

When using an electrically conductive additive in the polymeric coating composition, suitably the polymeric coating composition comprises from about 0.01% (by weight total polymeric coating composition) to about 10% (by weight total polymeric coating composition) electrically conductive additive. More suitably, the polymeric coating composition may comprise from about 0.1% (by weight total polymeric coating composition) to about 5% (by weight total polymeric coating composition) electrically conductive additive.

Additionally, additives for improving aesthetic properties and functional properties of the polymeric coated substrate can be added to the polymeric coating composition. For example, additives for improving gloss, finish, surface hardness, abrasion resistance, and surface frictional properties can be added to the polymeric coating composition

Once the polymeric coating composition has been formed, the polymeric coating composition is deposited onto a substrate. The polymeric coating composition may be deposited onto the substrate using any means known in the art. For example, suitable means for depositing the polymeric coating composition may include flexographic printing, rotogravure printing, offset printing, ink-jet printing, letterpress, direct gravure coating, offset gravure coating, reverse roll coating, flexographic coating, slot coating, dip coating, rod coating, knife coating, air knife coating, blade coating, slide coating, curtain coating, spraying, hot melt spraying, foam application, brushing, and embossing.

The amount of polymeric coating composition that can be deposited onto the substrate will depend on the substrate to be coated. Typically, the polymeric coating composition is deposited onto the substrate in an amount of from about 1 gram/meter² (gsm) to about 60 gsm. More suitably, the polymeric coating composition is deposited onto the substrate in an amount of from about 10 gsm to about 40 gsm.

The polymeric coating composition may be deposited onto the substrate in a continuous layer or a patterned layer. By using a patterned layer, a targeted design or figure can be produced on the surface of the substrate. Additionally, when the composition to be applied comprises an electrically conductive additive, by applying the composition in a pattern, circuitry for conducting electricity in a desired pattern or design can be produced. Suitably, the polymeric coating composition can be deposited in patterns including, for example, characters, an array of separate lines, swirls, numbers, dots, or the like. Continuous patterns, such as stripes or separate lines that run parallel with the machine direction of the web, are particularly preferred as these patterns may be more process-friendly.

Various substrates can be coated with the polymeric coating composition. For example, fibrous substrates, non-woven substrates, films, glass, metals, plastics, and textiles can be coated with the polymeric coating composition. As used herein, “non-woven” or “non-woven web” refers to materials or webs that are formed without the aid of a textile weaving or knitting process. Non-woven structures have been formed from many processes such as, for example, meltblowing processes, spunbonding processes, and bonded-carded processes.

Examples of particularly preferred substrates that can be coated with the polymeric coating composition include substrates for use in articles such as tissues, wipes, and absorbent articles such as feminine care pads, interlabial products, tampons, diapers, incontinence articles such as pads, guards, pants and undergarments, training pants, medical garments, bed pads, sweat absorbing pads, shoe pads, bandages, helmet liners, and the like.

In one particularly preferred embodiment, the substrate is a disposable absorbent article, specifically a diaper. Typically, a disposable absorbent article such as a diaper comprises a laminate having at least three separate substrate layers: a liquid permeable topsheet, a liquid impermeable backsheet, an absorbent core positioned between the liquid permeable topsheet and the liquid impermeable backsheet, any layer of which can be coated with the polymeric coating composition.

The topsheet presents a body-facing surface that is compliant, soft-feeling, and non-irritating to the wearer's skin. A suitable topsheet substrate layer may be manufactured from a wide selection of thermoplastic materials, such as porous foams, reticulated foams, thermoplastic materials, apertured plastic films, natural fibers (for example, wood or cotton fibers), synthetic fibers, or a combination of natural and synthetic fibers. Suitable synthetic fibers include polyethylene, polypropylene, polyester, KRATON® polymers, polyurethane, nylon, or combinations thereof. For example, the topsheet may be composed of a meltblown or spunbonded web of the desired fibers, and may also be a bonded-carded-web. In one embodiment, the topsheet layer is a non-woven, spunbonded polypropylene fabric composed of about 2.8-3.2 denier gsm and a density of about 0.06 gm/cc.

Additionally, the disposable absorbent article comprises a backsheet substrate layer. The backsheet layer is located along an outside surface of the absorbent article and desirably comprises a thermoplastic material which is configured to be substantially impermeable to liquids. For example, a typical backsheet layer can be manufactured from a thin plastic film, or other flexible, substantially liquid-impermeable material. As used in the present disclosure, the term “flexible” refers to materials which are compliant and which will readily conform to the general shape and contours of the wearer's body. Suitable thermoplastic materials for the backsheet layer can include polyethylene, polypropylene, or combinations thereof. In one particular embodiment of the absorbent article, the backsheet layer can include a film, such as a polyethylene film, having a thickness of from about 0.012 millimeters (0.5 mil) to about 0.051 millimeters (2.0 mil). For example, the backsheet film can have a thickness of about 0.032 millimeters (1.25 mil).

Alternative constructions of the backsheet substrate layer may comprise a woven or non-woven fibrous web which has been totally or partially constructed or treated to impart the desired levels of liquid impermeability to selected regions that are adjacent or proximate the absorbent core. For example, the backsheet layer may include a gas-permeable non-woven fabric material laminated to an appointed facing surface of a polymer film material that may or may not be gas-permeable. Ordinarily, the fabric material is attached to an outward-facing surface of the polymer film material. Other examples of fibrous, cloth-like backsheet layer materials are a stretch-thinned or a stretch-thermal-laminate material composed of a 0.015 mm (0.6 mil) thick polypropylene blown film and a 23.8 g/m² (0.7 ounce per square yard) polypropylene spunbond material (2 denier fibers).

In particular arrangements, a substantially liquid impermeable, vapor permeable backsheet layer may be a composite material which includes a vapor permeable film adhesively laminated to a spunbond material. The vapor permeable film can be obtained from Exxon Chemical Products Incorporated, under the tradename EXXAIRE. The film can include 48-60 weight percent (wt %) linear low density polyethylene and 38-50 wt % calcium carbonate particulates that may be uniformly dispersed and extruded into the film. The stretched film can have a thickness of about 0.018 mm (0.7 mil) and a basis weight of 16-22 grams per square meter (gsm). The spunbond material can be adhesively laminated to the film, and can have a basis weight of about 27 gsm. The spunbond material can be made using conventional spunbond technology, and can include filaments of polypropylene having a fiber denier of 1.5-3 dpf. The vapor-permeable film may be adhered to the spunbond material using a pressure sensitive, hot melt adhesive at an add-on rate of about 1.6 gsm, and the adhesive can be deposited in the form of a pattern of adhesive swirls or a random fine fiber spray. Another example of a suitable microporous film can be a PMP-1 material, which is available from Mitsui Toatsu Chemicals, Inc., a company having offices in Tokyo, Japan; or an XKO-8044 polyolefin film available from 3M Company of Minneapolis, Minn.

The liquid impermeable, vapor permeable backsheet layer may alternatively include a highly breathable stretch thermal laminate material (HBSTL). The HBSTL material can include a polypropylene spunbond material thermally attached to a stretched breathable film. For example, the HBSTL material may include a 20.4 gsm (0.6 osy) polypropylene spunbond material thermally attached to an 18.7 gsm stretched breathable film. The breathable film may include two skin components with each skin component composed of 1-3 wt % EVA/catalloy. The breathable film may also include 55-60 wt % calcium carbonate particulates, linear low density polyethylene, and up to 4.8% low density polyethylene. The stretched breathable film can include a thickness of 0.011-0.013 mm (0.45-0.50 mil) and a basis weight of 18.7 gsm. The spunbond material can be thermally bonded to the breathable film, and can have a basis weight of about 20.4 gsm. The spunbond material can have a fiber denier of 1.5-3 dpf, and the stretched breathable film can be thermally attached to the spunbond material using a “C-star” pattern that provides an overall bond area of 15-20%.

The third substrate layer of the disposable absorbent article is an absorbent core positioned between the liquid permeable topsheet and the liquid impermeable backsheet. The absorbent core may include a combination of hydrophilic fibers and high-absorbency material. More specifically, the high-absorbency material in the absorbent core can be selected from natural, synthetic, and modified natural polymers and materials. Suitable absorbent materials include cellulosic material, rayon, glass fibers, wood pulp fibers, polyester fibers, polyamide fibers, superabsorbent materials, polypropylene fibers, or combinations thereof. The absorbent core may also be slightly embossed in selected areas.

Other substrates that may suitably be coated with the polymeric coating composition are substrates for use in packaging articles. The term “packaging articles” can include bottles, containers, pots (e.g., jars), and boxes, such as boxes made of cardboard or a cardboard-like material (e.g., bendable sheet material).

In yet another embodiment, the substrates can include labels, such as labels to be adhered to the packaging articles listed above. When the substrate is a label, the substrate may comprise a synthetic film, such as, for example, polyethylene or polypropylene, having an adhesive face, and a sheet of removable paper, which may cover the adhesive face of the film in order to protect it.

The process for curing a polymeric coating composition to form a three-dimensional structure on a substrate further comprises subjecting the polymeric coated substrate to microwave irradiation. Typically, the microwave irradiation will occur under ambient temperature. The polymeric coating composition, however, will increase in temperature depending upon the amount of energy it receives from the microwave irradiation. The amount of energy will generally vary in accordance with the line speed of the coated substrate passing through the microwave cavity. Typically, the line speed will be from about 1 foot per minute to 5,000 feet per minute. More suitably, the line speed will be from about 5 feet per minute to about 2,500 feet per minute.

A suitable microwave generator utilized to subject the coated substrate to microwave irradiation is described in U.S. Pat. No. 5,536,921 issued Jul. 16, 1996 to Hedrick et al. and U.S. Pat. No. 5,916,203 issued Jun. 29, 1999 to Brandon, et al., both of which are hereby incorporated by reference in their entireties to the extent they are consistent herewith. Such a generator typically provides a plurality of microwave standing waves within an enclosure or cavity. The coated substrate can then be passed through the standing waves where the incident microwave energy can be utilized within the coated substrate to crosslink the polymeric coating composition. Microwave irradiation may then be supplied, continuously or intermittently, to the continuously moving coated substrate at a line speed as described above. A generator may also be configured to provide a variable amount of microwave irradiation relative to the speed of the coated substrate such that the irradiation provided increases as the line speed of the coated substrate increases. To provide such high levels of irradiation in such a short time period, it may be desirable to have more than one microwave cavity through which the coated substrate passes. For example, in one embodiment, a system used in the present disclosure may include from two to twenty cavities through which the coated substrate passes to provide the necessary microwave irradiation to activate the crosslinking action of the polymeric coating composition on the coated substrate.

Suitably, the polymeric coated substrate is subjected to microwave irradiation at a power of from about 10 watts to about 1 megawatt. More suitably, the polymeric coated substrate is subjected to microwave irradiation at a power of from about 1 kilowatt to 100 kilowatts.

The polymeric coated substrate may be exposed to the microwave irradiation for a period of from about 0.001 second to about 5 seconds. More suitably, the polymeric coated substrate may be exposed to the microwave irradiation for a period of from about 0.01 second to about 3 seconds. Such an exposure time may make it possible to both dry the polymeric coating composition and to obtain optimum cross-linking of the oligomer to form the three-dimensional structure on the substrate. Thus, this step may be relatively short and may provide for a very fast and therefore inexpensive method of curing the polymeric coating composition.

As noted above, the microwave irradiation will permit cross-linking of the polymeric coating composition, producing a three-dimensional structure on the polymeric coated substrate. This cured three-dimensional structure can be used to entrap colorants such as dyes, pigments, and inks on the coated substrate, producing colored substrates in an inexpensive, efficient manner.

As the polymeric coating composition produced in the present disclosure can be used on numerous different substrates, it is desirable that the flexibility of the polymeric coating composition can be controlled to better coat each individual substrate. Suitably, by controlling the molecular spacing between the functional groups of the oligomers and reactant compounds, the flexibility can be controlled. Specifically, as the distance between the functional groups is increased, thereby decreasing the density of the cross-linked compound, the polymeric coating composition forms a more flexible cured three-dimensional structure on a substrate.

In view of the above, it will be seen that the several objects of the disclosure are achieved and other advantageous results obtained.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the disclosure, it is intended that all matter contained in the above description shall be interpreted as illustrative and not in a limiting sense.

What is claimed is:

1. A process of curing a polymeric coating composition, the process comprising:
contacting a reactant compound with an oligomer to form a polymeric coating composition;
depositing the polymeric coating composition onto a substrate; and
subjecting the polymeric coated substrate to microwave irradiation such that the polymeric coating composition cross-links to form a three-dimensional structure on the substrate.

2. The process as set forth in claim 1 wherein the reactant compound is in liquid form and the oligomer is in liquid form.

3. The process as set forth in claim 1 wherein the reactant compound has at least one moiety selected from the group consisting of aliphatic epoxy, aromatic epoxy, aziridine, anhydride, and combinations thereof.

4. The process as set forth in claim 3 wherein the reactant compound is selected from the group consisting of butadiene dioxide, 2,2-Bis(4-glycidyloxyphenyl)propane, aliphatic diepoxide, aliphatic diacid glycidyl ester, tri-functional aziridine, succinic anhydride and styrene-ethylene/butylene(succinic anhydride)-styrene.

5. The process as set forth in claim 1 wherein the oligomer is selected from the group consisting of amines, alcohols, carboxylic acids, and combinations thereof.

6. The process as set forth in claim 5 wherein the oligomer is selected from the group consisting of ethylenediamine, hexamethylenediamine, polyvinyl alcohol, polyvinyl acetate, polyethylene glycol, polypropylene glycol, cellulosics, oxalic acid, malonic acid, succinic acid, glutaric acid, adipic acid, pimelic acid, maleic acid, and polyacrylic acid polymers.

7. The process as set forth in claim 1 wherein the polymeric coating composition comprises from about 0.01% (by weight total polymeric coating composition) to about 80% (by weight total polymeric coating composition) reactant compound and from about 20% (by weight total polymeric coating composition) to about 99.99% (by weight total polymeric coating composition) oligomer.

8. The process as set forth in claim 1 wherein the polymeric coating composition comprises from about 0.1% (by weight total polymeric coating composition) to about 60% (by weight total polymeric coating composition) reactant compound and from about 40% (by weight total polymeric coating composition) to about 99% (by weight total polymeric coating composition) oligomer.

9. The process as set forth in claim 1 further comprising introducing an electrically conductive additive into the polymeric coating composition prior to depositing the polymeric coating composition onto the substrate.

10. The process as set forth in claim 1 wherein the polymeric coating composition is deposited onto the substrate in an amount of from about 1 gram/meter to about 60 grams/meter².

11. The process as set forth in claim 1 wherein the substrate to be coated with the polymeric coating composition is selected from the group consisting of fibrous substrates, non-woven substrates, films, glass, metals, plastics, and textiles.

12. The process as set forth in claim 1 wherein the polymeric coated substrate is subjected to microwave irradiation at a power of from about 10 watts to about 1 mega watt.

13. A process of curing a polymeric coating composition, the process comprising:
contacting a reactant compound having an epoxy moiety with an oligomer to form a polymeric coating composition;
depositing the polymeric coating composition onto a substrate; and
subjecting the polymeric coated substrate to microwave irradiation such that the polymeric coating composition cross-links to form a three-dimensional structure on the substrate.

14. The process as set forth in claim 13 wherein the reactant compound is in liquid form and the oligomer is in liquid form.

15. The process as set forth in claim 13 wherein the reactant compound is selected from the group consisting of butadiene dioxide, 2,2-Bis(4-glycidyloxyphenyl)propane, aliphatic diepoxide, aliphatic diacid glycidyl ester.

16. The process as set forth in claim 13 wherein the oligomer is selected from the group consisting of amines, alcohols, carboxylic acids, and combinations thereof.

17. The process as set forth in claim 13 wherein the polymeric coating composition comprises from about 0.01% (by weight total polymeric coating composition) to about 60% (by weight total polymeric coating composition) reactant compound and from about 40% (by weight total polymeric coating composition) to about 99.99% (by weight total polymeric coating composition) oligomer.

18. The process as set forth in claim 13 wherein the polymeric coating composition is deposited onto the substrate in an amount of from about 1 gram/meter² to about 60 grams/meter².

19. The process as set forth in claim 13 wherein the polymeric coated substrate is subjected to microwave irradiation at a power of from about 10 watts to about 1 mega watt.

20. A process of curing a polymeric coating composition, the process comprising:
contacting a reactant compound with an oligomer to form a polymeric coating composition, wherein the reactant compound is a tri-functional aziridine;
depositing the polymeric coating composition onto a substrate; and
subjecting the polymeric coated substrate to microwave irradiation such that the polymeric coating composition cross-links to form a three-dimensional structure on the substrate.

21. The process as set forth in claim 20 wherein the tri-functional aziridine is in liquid form and the oligomer is in liquid form.

22. The process as set forth in claim 20 wherein the oligomer is selected from the group consisting of alcohols, carboxylic acids, and combinations thereof.

23. The process as set forth in claim 20 wherein the polymeric coating composition comprises from about 0.01% (by weight total polymeric coating composition) to about 60% (by weight total polymeric coating composition) reactant compound and from about 40% (by weight total polymeric coating composition) to about 99.99% (by weight total polymeric coating composition) oligomer.

24. The process as set forth in claim 20 wherein the polymeric coating composition is deposited onto the substrate in an amount of from about 1 gram/meter² to about 60 grams/meter².

25. The process as set forth in claim 20 wherein the polymeric coated substrate is subjected to microwave irradiation at a power of from about 10 watts to about 1 mega watt.

26. A process of curing a polymeric coating composition, the process comprising:
contacting a reactant compound having an anhydride moiety with a polyvinyl alcohol to form a polymeric coating composition;
depositing the polymeric coating composition onto a substrate; and
subjecting the polymeric coated substrate to microwave irradiation such that the polymeric coating composition cross-links to form a three-dimensional structure on the substrate.

27. The process as set forth in claim 26 wherein the reactant compound is in liquid form and the polyvinyl alcohol is in liquid form.

28. The process as set forth in claim 26 wherein the reactant compound is selected from the group consisting of succinic anhydride and styrene-ethylene/butylene(succinic anhydride)-styrene.

29. The process as set forth in claim 26 wherein the polymeric coating composition comprises from about 0.1% (by weight total polymeric coating composition) to about 80% (by weight total polymeric coating composition) reactant compound and from about 20% (by weight total polymeric coating composition) to about 99.9% (by weight total polymeric coating composition) polyvinyl alcohol.

30. The process as set forth in claim 26 wherein the polymeric coating composition is deposited onto the substrate in an amount of from about 1 gram/meter² to about 60 grams/meter².

31. The process as set forth in claim 26 wherein the polymeric coated substrate is subjected to microwave irradiation at a power of from about 10 watts to about 1 mega watt.
